(19) United States
(12) Patent Application Publication
(10) Pub. No.: US 2008/0059562 A1
(43) Pub. Date: Mar. 6, 2008

(54) Method and system for localized information retrieval

(76) Inventor: Brad G. Jones, Beverly Hills, CA (US)

Correspondence Address: STETINA BRUNDA GARRED & BRUCKER, 75 ENTERPRISE, SUITE 250, ALISO VIEJO, CA, 92656, US

(21) Appl. No.: 11/895,698

(22) Filed: Aug. 27, 2007

Related U.S. Application Data
(60) Provisional application No. 60/842,394, filed on Sep. 5, 2006.

(51) Int. Cl. G06F 15/16

(52) U.S. Cl. 709/202

(57) ABSTRACT

A method and system for transferring localized information from a central database to a portable data processing device. The localized information is transferred from the central database to a wireless broadcasting device in a remote location, and the localized information is specific or particular to the remote location. A data communications link established by the wireless broadcasting device to the portable data processing device is used to transmit the localized information to the user.

### CROSS-REFERENCE TO RELATED APPLICATIONS

This application relates to and claims the benefit of U.S. Provisional Application No. 60/842,394 filed Sep. 5, 2006 and entitled A METHOD FOR LOCALIZED INFORMATION RETRIEVAL, which is wholly incorporated by reference herein.

### STATEMENT RE: FEDERALLY SPONSORED RESEARCH/DEVELOPMENT

Not Applicable

### BACKGROUND

1. Technical Field

The present invention relates generally to information retrieval. More particularly, the present invention relates to methods and systems for distributing location-specific information. The invention also relates to methods and systems for delivering location-specific data from a central database to end-user portable electronic devices.

2. Related Art

Many people aspire to achieve home ownership, and desire to get the best deal they can. It is well recognized that a sound real estate purchasing decision must be based upon a thorough investigation and understanding of the market conditions, of the details pertaining to as many pieces of property as possible, and so forth. Presently, a prospective homeowner has a number of options for obtaining information concerning property listings on the market, and more generally, has a variety of strategies to employ while searching for a suitable property to buy.

A traditional method of purchasing real estate is by retaining the services of a real estate agent. The agent will typically have at least a working knowledge of a particular area of the market, and the buyer may specify to the agent any particular features, characteristics, and/or location that are desired. Based on this initial query, an agent may search the Multiple Listing Service (MLS) database to locate currently available properties. Upon locating properties matching the buyer's requirements, the agent and the buyer may visit the particular property of interest before making a purchase offer.

The MLS database contains a set of property listing records describing real estate properties being offered for sale, leasing, or rental for a defined geographic region. Real estate brokers representing the sellers under a listing contract typically list the property for maximum exposure to interested buyers. Each listing identifies and describes the various characteristics of the property in a standard, pre-defined format, which can be easily and accurately be searched. Listings can also include maps and photographs of the property. The characteristics also include pricing and tax information, including the price and terms at which a particular property previously sold. In this regard, MLS databases typically include the ability to archive historical purchase information. Additionally, MLS databases provide access to new or updated listing information.

Although earlier MLS database systems are accessed with character-based terminals over a dedicated data line or a telephone line with a modem, conventional MLS systems are graphical and may be accessed over the Internet. Accordingly, it is no longer necessary for a buyer to engage the services of a real estate agent during the initial stages of a purchase since the buyer may query the MLS database over a web-based interface to conduct research and narrow down what could potentially be an enormous list of properties on the market.

Despite the undeniable convenience of being able to search for real estate on the Internet from the home or the office at any time of the day without assistance from a real estate agent, textual property details, pictures and video are wholly inadequate for making a purchasing decision. Thus, it is still necessary for the buyer to visit each of the properties. Having obtained the exact addresses for the properties through the MLS database, the buyers can look up the locations manually with a map. Alternatively, the MLS system may generate a map with directions to each of the properties.

Another, more informal method of researching real estate is by driving or otherwise visiting a desirable neighborhood or area, and looking for various “for sale” or “open house” signs posted in front of the property or in other conspicuous locations. However, this approach is inefficient, particularly because in order to obtain further information, the prospective buyer must contact the agent by either setting up an appointment for a showing or by taking a tour by way of the open house. For example, without learning about the basics of the property such as the number of bedrooms and bathrooms, the square footage, and so forth, it would be imprudent for the buyer to contact the agent immediately. Nevertheless, this research technique remains popular for those unwilling or unable to conduct research on the Internet. In order to reduce some of the inefficiencies of this method, devices and systems such as that disclosed in U.S. Pat. No. 6,385,541 to Blumberg, et al. has been proposed. The Blumberg, et al. device includes a Global Positioning System (GPS) receiver, and the position derived therefrom is used to query a real estate database for available properties in the vicinity. The query returns a list of addresses of properties for sale. Additionally, the Blumberg et al. device contemplates the use of alternative position determination schemes in conjunction with cellular phones, such as CDMA cellular positioning technology, cell ID, and so forth. However, as will be appreciated by one of ordinary skill in the art, any position-determination technology, whether performed via hardware such as GPS receivers or through additional processing by mobile phone providers, adds further levels of complexity. Accordingly, they have not seen widespread use.

Further improvements have been proposed, such as the Real Estate Information Search and Retrieval System described in U.S. Pat. No. 6,636,803 to Hartz, Jr., et al. The device teaches the use of GPS receiver with mapping capabilities, and the superimposition of icons representative of available properties on the map. The details regarding the available properties are retrieved from a remote server, and displayed on the device as well. Thus, it is possible to specify a predetermined list of properties to display on the map for those buyers wishing to conduct research on the Internet prior to visiting the individual properties, and it is possible to show a list of all available properties in the vicinity. While improving the real estate purchasing process, the Hartz, Jr., et al. device is highly specialized. Conventional GPS receivers/mapping devices are unsuitable to be retrofitted with the added functionality due to the screen real estate requirements for displaying the MLS information in conjunction with the map.

Both of the above-described devices require individual users to connect to the MLS database, leading to access control problems stemming from the necessity to manage all such connections. Although MLS information is important to make available to prospective buyers, it is necessary to restrict its access by the general public for privacy and other considerations. While various well-known access control mechanisms may be implemented on the devices or on the MLS database, the proprietary and confidential information remains vulnerable. Since a greater number of devices will be accessing a greater volume of data through just one system, there is a greater likelihood of large-scale information leaks.

Therefore, there is a need in the art for a method to distribute localized MLS information to potential real estate buyers without connecting directly to an MLS database. It would also be desirable for the buyers to access this information with conventional, non-specialized electronic data processing devices, such as a cellular phone, without the use of GPS or other positioning technology.

### BRIEF SUMMARY

In accordance with an aspect of the present invention, there is provided a method for transferring localized information from a central database in a first location to a portable data processing device situated in a second location. The method may include the step of storing the localized information to a wireless broadcasting device situated in the second location. The localized information may be retrieved from the central database and further may be distinctive to the second location. The method may also include the step of initiating a data communications link between the wireless broadcasting device and the portable data processing device. The wireless broadcasting device may have a predetermined transmission range within the vicinity of the second location. The device may also be responsive to a connection request from the portable data processing device. The method may also include the step of transmitting the localized information stored on the wireless broadcasting device to the portable data processing device of the data communications link therebetween.

In one embodiment, the central database may be a real estate Multiple Listing Service (MLS) server. The localized information may be a listing record including a set of characteristics describing a real estate property listing relating to the second location. The localized information may also be a video tour of the real estate property listing relating to the second location. Further, the localized information may also be a restaurant menu including a description of food items offered for sale at a restaurant at the second location and associated with the wireless broadcasting device.

In another embodiment, a system for delivering localized information to a user communication device in a remote location includes a central database and a local broadcasting device. The central database may include localized information specific to the remote location, and may be remotely situated with respect to the remote location. The local broadcasting device may be in communication with the central database and with the user communication device, and includes a data request module. The data request module may retrieve the localized information specific to the remote location from the central database. The local broadcasting device may be situated in the remote location.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a perspective view of a real estate property for sale as advertised by a sign in accordance with an aspect of the present invention;

FIG. 2 is a front view of the sign;

FIG. 3 is a block diagram of an exemplary system for performing the method of transferring localized information in accordance with an aspect of the present invention;

FIG. 4 is a flowchart showing the steps included in a method for transferring localized information from one location to another;

FIG. 5 is a block diagram illustrating various logical modules of a wireless broadcasting device in accordance with an aspect of the present invention;

FIG. 6 is a block diagram of the hardware components of the wireless broadcasting device;

FIG. 7a is an illustration of a user in close proximity to the wireless broadcasting device located within the real estate property for sale; and

FIG. 7b is an illustration of a user distant from the wireless broadcasting device within the real estate property for sale, but still within the reception range.

Common reference numerals are used throughout the drawings and the detailed description to indicate the same elements.

### DETAILED DESCRIPTION

The detailed description set forth below in connection with the appended drawings is intended as a description of the presently preferred embodiment of the invention, and is not intended to represent the only form in which the present invention may be constructed or utilized. The description sets forth the functions and the sequence of steps for developing and operating the invention in connection with the illustrated embodiment. It is to be understood, however, that the same or equivalent functions and sequences may be accomplished by different embodiments that are also intended to be encompassed within the spirit and scope of the invention. It is further understood that the use of relational terms such as first and second and the like are used solely to distinguish one from another entity or step without necessarily requiring or implying any actual such relationship or order between such entities.

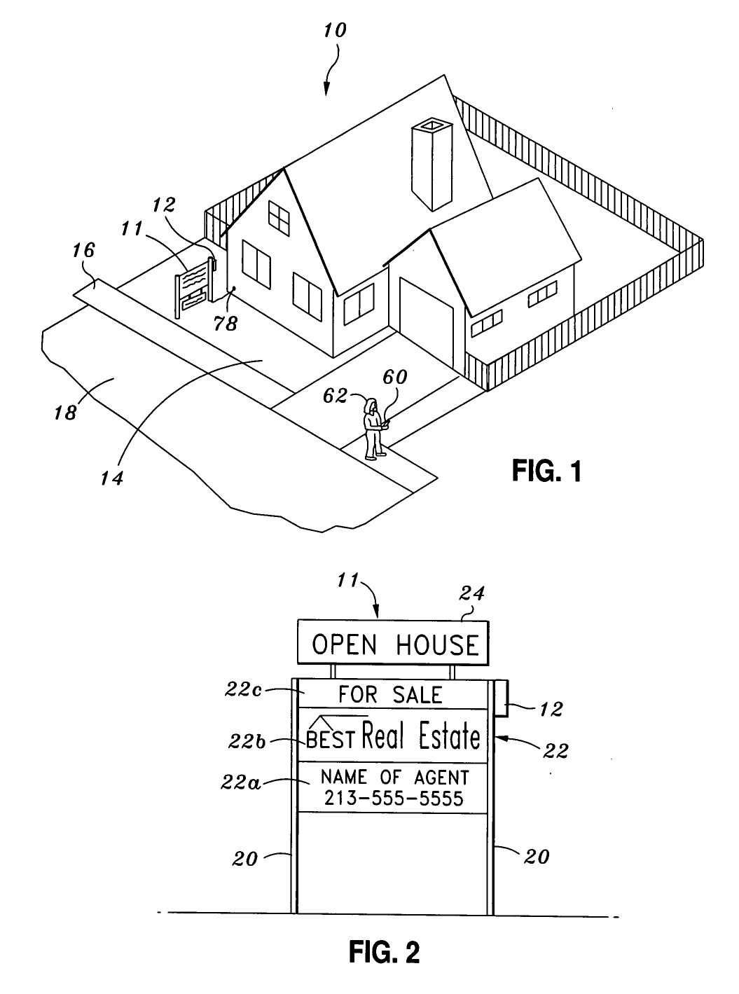

With reference to FIG. 1, an exemplary real estate property 10 being offered for sale is illustrated, including a combination sign 11 and broadcast device 12 in accordance with an aspect of the present invention. The sign 11 is placed on a front lawn 14 or other like frontage of the property 10 that is adjacent to a publicly accessible sidewalk 16 or a road 18 so as to attract the attention of casual passerby as well as those specifically seeking to visit the property 10. As shown in FIG. 2, the typical sign 11 is supported by a pair of opposed legs 20, and a sign face 22. The sign face 22 may be divided into multiple segments, including a segment for indicating the particular agent or broker handling the property and his or her phone number as shown in segment 22a, and a segment 22b for indicating the company with which the agent or broker is affiliated. Furthermore, the sign face 22 may include a segment 22c for bringing attention to the fact that the real estate property 10 is on sale. The sign 12 may include a removable attachment 24 for indicating that an open house is in progress. It is understood that an agent may install the attachment 24 prior to an open house, and remove the same upon concluding the open house. A variety of well known mechanisms are available for retaining the attachment 24 to the sign 12. Further, the sign 11 may be constructed of any suitably durable material such as steel, plastic, or plastic-reinforced cardboard. An exemplary sign 11 has been described above, and a person having ordinary skill in the art will recognize that there are many other alternative configurations that may be utilized without departing from the scope of the present invention.

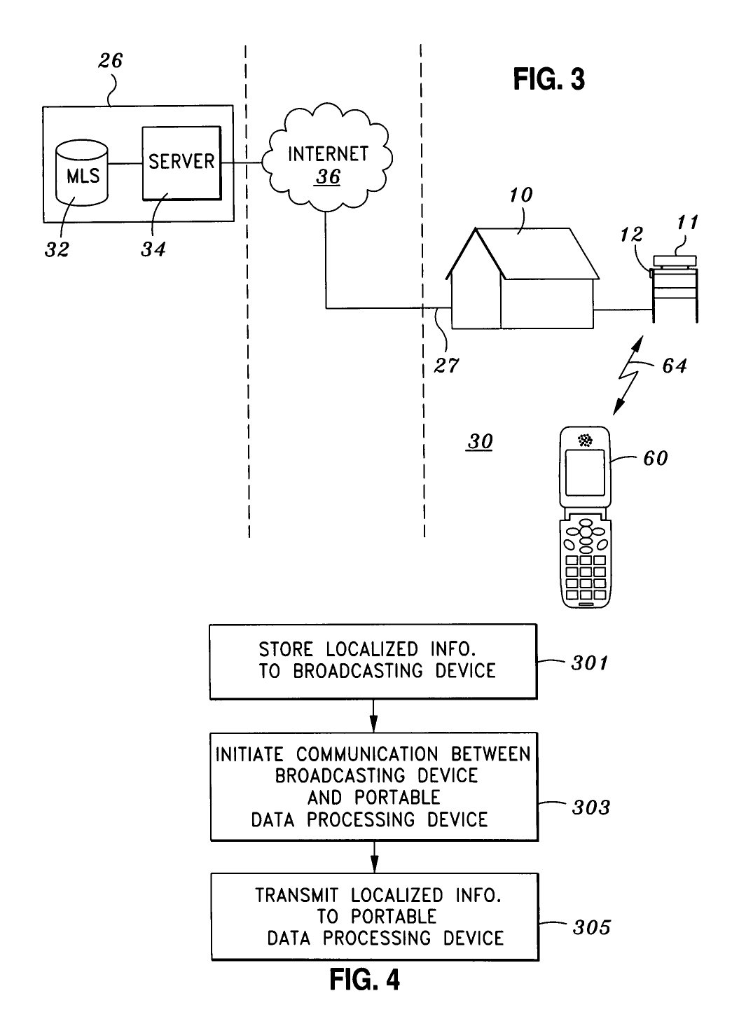

With reference to FIGS. 3 and 4, according to one aspect of the present invention, there is disclosed a method for transferring localized information to a data processing device. As used herein, the term “localized information” refers to location-specific information, for example, information relating to a particular MLS listing of the property 10. By way of example only and not of limitation, such information may include address, unit number, lot number, etc., as well as price, amenities, numbers and types of bathrooms, bedrooms, lot size, model type, status data such as whether the property is available, been sold, or is in escrow, and MLS listing numbers which may be used for future reference or tracking purposes. Other data not usually found in an MLS listing may also be a part of the localized information, such as one or more digital images such as JPEG files or movie clips such as MPEG files of the real estate property 10. It is additionally contemplated that the method be utilized to distribute other types of information, including restaurant menu items. Furthermore, multiple MLS listings and other such localized information may be transmitted from the broadcasting device 12. The broadcasting device 12 may be fixed or placed in the vicinity of bus benches, billboards, and other like outdoor and indoor structures commonly utilized for advertising. In this regard, the multiple MLS listings may be associated with a single broker to which the bench or billboard advertising pertains. One of ordinary skill in the art will be able to recognize the numerous settings and locations in which the broadcasting device 12 may be utilized.

The localized information may be stored on a central database 26 situated in a first location 28. The central database 26 may additionally include data pertaining to other properties in the same geographic area. There are separate MLS systems each serving a particular geographic area. The systems may be owned by a single real estate company, a county or regional real estate board, or a trade association operating in that geographic area. The first location 28 may be associated with and under the control of any such entities. Generally, the first location 28 is remote to a second location 30, which is the site of the real estate property 10.

According to a preferred embodiment of the present invention, the central database 26 includes an MLS database 32 and a web server 34. The web server 34 is enabled to execute instructions that are operative to receive and respond to queries upon the MLS database 32 from an Internet 36. Additionally, the web server 34 may be capable of receiving input from a remote user (not shown) such as a sellers' agent or broker who desires to add a listing to the MLS database 30. In this case, the web server 34 receives the submitted information, and transmits instructions to the MLS database 32 to write such submitted information thereto. While particular reference has been made to the Internet 36, any other suitable Wide Area Network (WAN) capable of data transfer functionality may be readily substituted without departing from the scope of the present invention.

It will be recognized by one of ordinary skill in the art that any hardware and database management system software may be utilized to implement the MLS database 32, including relational database systems such as SQL and the like running on any computing platform, including MICROSOFT WINDOWS, UNIX, etc. Typically, the MLS database 32 is configured to have particular fields relating to the above-indicated characteristics of the real estate property 10, and such configurations of the fields are particular to the database management system software being utilized. To preserve confidentiality and ensure the integrity of the data, the central database 26 may include authentication and access control systems, which limit access to the MLS database 32 to known users with proper credentials such as passwords, digital certificates, and the like.

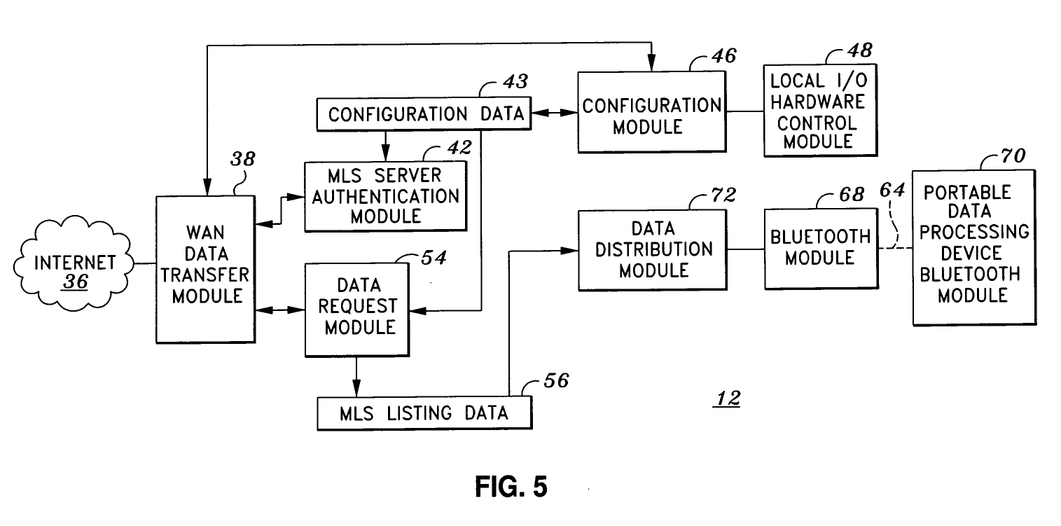

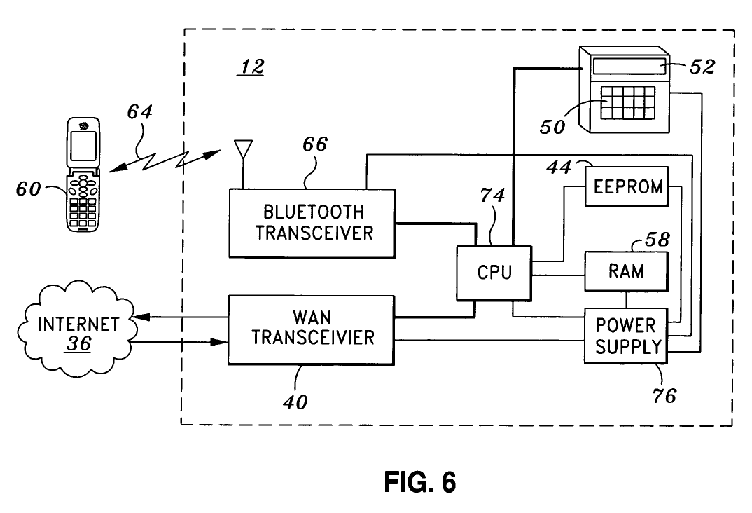

Referring to FIG. 4, the method for transferring localized information includes a step 301 of storing the localized information to the wireless broadcasting device 12. The localized information is retrieved from the central database 26 over the Internet 36, and is particular to the second location 30, that is, the real estate property 10. With reference to FIGS. 5 and 6, further specifics of the wireless broadcasting device 12 will be discussed. FIG. 5 is a logical block diagram of basic functionality provided by the wireless broadcasting device 12, and FIG. 6 is a block diagram of the hardware components included in the same. As an initial matter, a WAN data transfer module 38 establishes a connection to the Internet 36, and to the central database 26. Per the exemplary implementation of the invention, the WAN data transfer module 38 handles network and transport level communications according to the TCP/IP protocol. The physical connection to the Internet 36 is provided by a WAN transceiver 40, which may conform to any one of data link protocols such as Ethernet, WiFi, Token Ring, and so forth. With reference to FIG. 3, it is assumed that a typical real estate property 10 includes some kind of data connectivity 27 capable of communicating with an Internet Service Provider (ISP), including narrowband services such as regular voice telephone service where modems may be utilized to connect to the ISP, as well as broadband services such as cable Internet or Digital Subscriber Line (DSL). It is expressly contemplated that the wireless broadcasting device 12 communicates with the central database 26 over the aforementioned services. Although specific connectivity means have been mentioned, it will be recognized that the present invention need not be limited to those specific means, and any other suitable means may be utilized without departing from the spirit and scope of the present invention.

As indicated above, access to the central database 26, and specifically the MLS listing information contained within the MLS listing database 32, is typically limited to authorized users only. Prior to initiating a download of the localized information, a MLS server authentication module 42 authenticates the wireless broadcasting device 12 to the central database 26. Specifically, the authentication module retrieves certain pre-programmed configuration data 43 from an Electrically Erasable Programmable Read-Only Memory (EEPROM) module 44 and transmits it to the central database 26. The configuration data 43 may include such information as a unique identification number for the particular wireless broadcasting device 12, an agent/broker identification number, a digital certificate, a security pass code, and a property identification number that particularly identifies the real estate property 10 within the MLS database 32. Since these values are not frequently modified, it is suited for storage on the more permanent EEPROM module 44.

The modification of these values is envisioned to be handled by a configuration module 46. Further authentication may be necessary to modify certain values. In one preferred embodiment, the configuration module 46 may receive instructions and value changes from a remote computer over the Internet 36. In this mode, the configuration module 46 essentially acts as a web server, and communicates with the WAN data transfer module 38 to receive and process these changes for updating the configuration data 43. Alternatively, the configuration module 46 directly receives changes through a local input/output hardware control module 48. The hardware control module 48 interfaces with a keyboard 50 for receiving input therefrom and with an output screen 52 for displaying configuration options. The keyboard 50 and the output screen 52 may be connected to the broadcast device 12 via an input/output channel 53. The keyboard 50 and the output screen 52 may be combined into a single unit, or the output screen 52 may be provided with touch-input capabilities. It is understood that any suitable input/output device may be utilized.

Upon establishing a connection between the wireless broadcasting device 12 and the central database 26, the location specific information is retrieved and stored. Specifically, data relating to the particular MLS listing of the real estate property 10 as specified in the configuration data 43 is retrieved. A data request module 54 transmits a query to the central database 26, and the central database transmits the requested data in response. The returned MLS listing data is stored as property data 56 in a Random Access Memory (RAM) 58. It is contemplated that the property data 56 be periodically updated to reflect any changes to the particular listing on the MLS database 32, with the update frequency being specified in the configuration data 43. Because of frequent updating, the property data 56 is stored in the RAM 58. In this regard, because the RAM 58 is volatile, it will be necessary to retrieve the property data 56 each time the wireless broadcasting device 12 is turned on. In alternative embodiments, both the RAM 58 and the EEPROM 44 may be substituted with a Flash-type memory device so as to avoid the aforementioned refresh upon powering up. As a further alternative configuration, it is expressly contemplated that the MLS database 32 initiates a communications link with the wireless broadcasting device 12 and “pushes” the property data 56 thereto whenever it is updated on MLS database 32.

As mentioned above, it is also possible to distribute data not traditionally included in the MLS listings, such as pictures and video tours of the real estate property 10. The data request module 54 has the additional functionality to query alternative data sources for such multimedia content. The location/address of these data sources may be specified in the configuration data 43, and be queried to return data in the same manner as indicated above in relation to the central database 26.

Referring back to FIG. 3, the method for transferring localized information continues with step 303, where communications between the wireless broadcasting device 12 and a portable data processing device 60 is initiated. With reference back to FIG. 1, a casual passerby 62 of the real estate property 10 may notice the real estate sign 12, and become desirous of acquiring further information. The passerby/user 62 is using the portable data processing device 60 that includes data communication means. By way of example only and not of limitation, the portable data processing device 60 is a cellular phone having BLUETOOTH communications capabilities. Additionally, the portable data processing device 60 includes functionality, preferably in an executable program stored in a memory, to transmit queries and display responses from the wireless broadcasting device 12. In a preferred embodiment, such executable program is a JAVA applet pre-loaded onto the portable data processing device 60. The user 62 directs the portable data processing device 60 to initiate a wireless data communications link 64, also referred to as a BLUETOOTH connection.

As will be appreciated by one of ordinary skill in the art, BLUETOOTH is a wireless personal area network specification, with compliant devices that are in relatively close proximity to each other being enabled to exchange information. The BLUETOOTH specification calls for multiple classes of transmission power and range, with the highest power output being 100 mW and having a range of about 100 meters, the medium power output being 2.5 mW and having a range of about 10 meters, and the lowest power output being 1 mW and having a range of about 1 meter. The actual transmission range may be extended by the use of antennae, but other factors which tend to attenuate the signal may reduce the range.

To implement the BLUETOOTH specification, the wireless broadcasting device 12 includes a BLUETOOTH transceiver 66, and a BLUETOOTH module 68 for controlling the same. To clarify, the BLUETOOTH transceiver 66 refers to the hardware device that generates and receives the electrical signals representative of the BLUETOOTH transmissions, and the BLUETOOTH module 68 refers to the software module that controls the processing of the BLUETOOTH transmissions. It is understood that the portable data processing device 60 also include a corresponding BLUETOOTH transceiver (not shown) and a BLUETOOTH module 70. Per the BLUETOOTH specifications, up to six additional (seven total) portable data processing devices may be connected simultaneously to the wireless broadcasting device 12 and actively transfer data therebetween.

Upon initiating the wireless data communications link 64 from the portable data processing device 60, a request to transmit the property data 56 thereto is received by the BLUETOOTH transceiver 66 and processed by the BLUETOOTH module 68. A data distribution module 70 receives this request, and retrieves the property data 56 from the RAM 58 in which it is stored. As shown in FIG. 4, the method of transferring localized information concludes with step 305 of transmitting such localized information to the portable data processing device 60.

All of the above functionality of the various modules are performed by a central processing unit (CPU) 74 and is powered by a power supply 76. The CPU 74 may be any desirable data processor, and the scope of the present invention is not limited to any particular type, make, or model. The power supply 76 may be a battery when using the wireless broadcasting device 12 in locations distant from any existing power lines, or it may comprise additional power supply circuitry for connection to a nearby standard household Alternating Current power line.

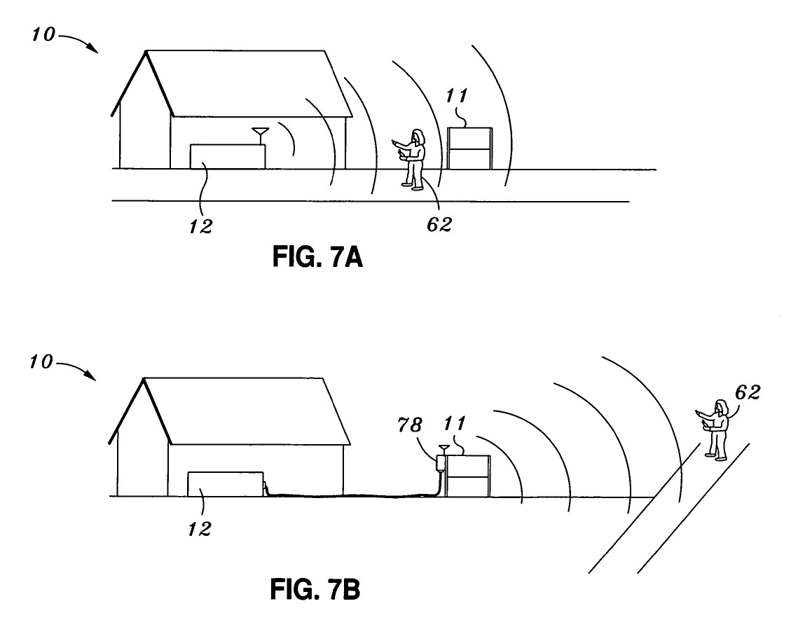

It is expressly contemplated that various components of the wireless broadcasting device 12 may be disposed in one stand-alone unit or may be separated. For example, as shown in FIG. 1, all of the components of the wireless broadcasting device 12 are attached to the sign 11. Such a configuration would be suitable for areas having little inclement weather. Furthermore, it would be suitable where a power socket 76 is nearby. Another preferred embodiment of the present invention is illustrated in FIG. 7a, which contemplates placing the wireless broadcasting device 12 indoors and separate from the sign 11, where sensitive electronic components are protected from rain, thunderstorms, hurricanes, and the like. Additionally, in high-crime areas, the wireless broadcasting device 12 may be hidden from potential thieves. This configuration allows for ready access to any of the above-described Internet access means, as well as to a power source. Furthermore, this configuration is appropriate where the wireless broadcasting device 12 is located sufficiently close to the frontage of the property 10 where passerby can still receive the BLUETOOTH signal. When this is not the case, as illustrated in FIG. 7b, it may be necessary to attach an antenna 78 to the sign 11, with a separate wired or wireless bridge connection 80 to the wireless broadcasting device 12. By placing the antenna on the sign 11, those persons 62 viewing the same can receive the BLUETOOTH signal. From the above description of the various possible configurations with respect to the sign 11 and the wireless broadcasting device 12, one of ordinary skill in the art will be able to deduce further alternative configurations, depending on the operating conditions. Any such configurations are deemed to come within the spirit and scope of the present invention.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show any more detail than is necessary for the fundamental understanding of the present invention, the description taken with the drawings making apparent to those skilled in the art how the several forms of the present invention may be embodied in practice.

What is claimed is:

1. A method for transferring localized information from a central database in a first location to a portable data processing device in a second location, the method comprising the steps of:
storing the localized information to a wireless broadcasting device in the second location, the localized information being retrieved from the central database and distinctive to the second location;
initiating a data communications link between the wireless broadcasting device and the portable data processing device, the wireless broadcasting device having a predetermined transmission range about the vicinity of the second location and being responsive to a connection request from the portable data processing device; and
transmitting the localized information stored on the broadcasting device to the portable data processing device over the data communications link therebetween.

2. The method of claim 1, wherein the central database is a real estate Multiple Listing Service (MLS) server, and the localized information is a listing record including a set of characteristics describing a real estate property listing relating to the second location.

3. The method of claim 1, wherein the localized information is a video tour of a real estate property listing relating to the second location.

4. The method of claim 1, wherein the localized information is one or more graphical images of a real estate listing relating to the second location.

5. The method of claim 1, wherein the localized information is a restaurant menu including a description of food items offered for sale at a restaurant at the second location and associated with the wireless broadcasting device.

6. The method of claim 1, wherein the portable data processing device is a cellular phone.

7. The method of claim 1, wherein the data communications link between the wireless broadcasting device and the portable data processing device is Bluetooth-compliant.

8. A system for delivering localized information to a user communication device in a remote location, the system comprising:
a central database including the localized information specific to the remote location, the central database being remotely situated with respect to the remote location; and
a local broadcasting device in communication with the central database and with the user communication device, the local broadcasting device being situated in the remote location;
wherein the local broadcasting device includes a data request module for retrieving from the central database the localized information specific to the remote location.

9. The system of claim 8, wherein the data request module queries the central database at a predetermined interval for updated localized information.

10. The system of claim 8, wherein the central database initiates a communications link with the local broadcasting device to transfer the localized information to the local broadcasting device in response to updates applied thereto.

11. The system of claim 8, wherein the local broadcasting device further includes:
an authentication module for validating access credentials with the central database, access to the central database being restricted until being provided with valid access credentials;
wherein the access credentials are stored on the local broadcasting device.

12. The system of claim 8, wherein the local broadcasting device further includes:
a wireless transceiver for establishing a communications link with the user communication device, the transmission length of the wireless transceiver being limited to the vicinity of the local broadcasting device.

13. The system of claim 12, wherein the wireless transceiver is Bluetooth-compliant.

14. The system of claim 12, wherein the established communications link is a wireless local area network.

15. The system of claim 8, wherein the central database is a real estate Multiple Listing Service (MLS) server, and the localized information is a listing record including a set of characteristics describing a real estate property listing relating to the remote location.

16. The system of claim 8, wherein the localized information is a video tour of a real estate property listing relating to the remote location.

17. The system of claim 8, wherein the localized information is one or more graphical images of a real estate listing relating to the remote location.
